(19) United States
(12) Patent Application Publication
(10) Pub. No.: US 2016/0140543 A1
(43) Pub. Date: May 19, 2016

(54) Secure Payment and Reporting System

(71) Applicant: FLOWPAY CORPORATION, INC., Highlands Ranch, CO (US)

(72) Inventor: Robert Wayne Steiger, Denver, CO (US)

(21) Appl. No.: 14/942,886

(22) Filed: Nov. 16, 2015

Related U.S. Application Data
(60) Provisional application No. 62/080,920, filed on Nov. 17, 2014.

(51) Int. Cl. G06Q 20/38; H04L 29/06

(52) U.S. Cl. CPC G06Q 20/382; H04L 63/04

(57) ABSTRACT

Payment data is received from a client device at a payment application in a reporting system. The payment data includes sensitive payment data required for processing a payment and non-sensitive payment data required by a report recipient that describes the processed payment. The payment data is separated into the sensitive payment data and the non-sensitive payment data. An electronic report is generated, by a report generator, which describes the payment. The generating includes: accessing a data warehouse storing at least one report template required by the report recipient, creating the electronic report based the stored report templates. And populating the electronic report with a portion of the non-sensitive payment data and excluding any of the sensitive payment data. The electronic report is transmitted to the report recipient over the communication network by the payment application. The sensitive payment data is transmitted to a payment processor over the communication network.

### CROSS-REFERENCE TO RELATED APPLICATIONS

The current application is related to/claims priority under 35 U.S.C. §119(e) to application No. 62/080,920 filed Nov. 17, 2014.

### TECHNICAL FIELD

The subject matter described herein relates to bifurcated processing of incoming data according to data type. Specifically, the partitioning of incoming data into two data types and the processing of each data type based on a required formatting.

### BACKGROUND

Payments to business entities, including corporations, non-profits, churches, etc. can be performed by submission of credit card information to the business entities. Frequently, third-party vendors provide payment applications for secure and easy processing of payments. Payment records, receipts, etc. are generated that provide detailed information about payments. The payment records can be used by the payer or payee to confirm payment transactions, as required by government agencies.

### SUMMARY

In one aspect, payment data is received from a client device at a payment application in a reporting system. The payment data includes sensitive payment data required for processing a payment and non-sensitive payment data required by a report recipient that describes the processed payment. The payment data is separated into the sensitive payment data and the non-sensitive payment data. An electronic report is generated, by a report generator, which describes the payment. The generating includes: accessing a data warehouse storing at least one report template required by the report recipient, creating the electronic report based the stored report templates. And populating the electronic report with a portion of the non-sensitive payment data and excluding any of the sensitive payment data. The electronic report is transmitted to the report recipient over the communication network by the payment application. The sensitive payment data is transmitted to a payment processor over the communication network.

In some variations, the following can be included in any feasible combination.

The payment data can be tokenized to prevent the reporting system from accessing private financial information contained in the sensitive payment data.

The electronic report can be generated automatically upon receiving the payment data. The automatically generated electronic report can be transmitted to the report recipient.

A selection of one or more report recipients from collection of report recipients can be received. The report generator can generate the electronic report based on the report template that corresponds to the selected report recipients. The electronic report can include non-sensitive payment data relating to a previous payment.

The current subject matter provides many technical advantages. For example, payment data can be divided into sensitive payment data and non-sensitive payment data, improving the security of the user's financial data by not storing financial data on the secure payment and reporting system.

Also, reports can be generated, manually or automatically, to be sent to third party agencies to comply with tax or other required government reporting.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a secure payment and reporting system;

FIG. 2 is a process flow diagram illustrating the bifurcation of payment data payment processing and report generation;

FIG. 3 is a process flow diagram illustrating data user entry processes;

FIG. 4 is a process flow diagram illustrating non-profit webpage functionality; and

FIG. 5 is a process flow diagram illustrating individual onsite enrollment.

### DETAILED DESCRIPTION

The current subject matter is directed to methods, systems, apparatus, articles/computer program products for making secure payments and reporting information about payments to third parties.

As used in the application, the term “non-profit” can refer to any type of business or legal entity that is entitled to non-profit status under state or federal law. Non-profits can include charities, churches, issue organizations, educational organizations, etc. The term “non-profit” is not intended to be exclusive or limiting in any way with regard to the types of business entities to which the term refers.

As used in the application, the term “payer” refers to the person or business entity making a payment or donation using the secure payment and reporting system. The term “payee” refers to the person or business entity that the penultimate recipient of the payment or donation processed by the secure payment and reporting system. The term “intermediary” refers to the person or business entity that facilitates the payment or donation and can include the business entity responsible for executing the secure payment and reporting system.

The secure payment and reporting system facilitates the payment from a payer, to a payee, via an intermediary. However, the secure payment and reporting system provides a bifurcated processing system which, in addition to processing the payment via check, cash, credit card, and so on, generates reports that can be used by any of the parties, or transmitted to government agencies to comply with tax codes, monitoring regulations, etc. The secure payment and reporting system streamlines what can be a bureaucratically difficult process by handling the reporting requirements for the payment and removing much of the burden from the payer. Without the substantial burden of doing the work involved in complying with reporting requirements, this can greatly increase the likelihood and frequency of using the system for payments or the making of charitable donations.

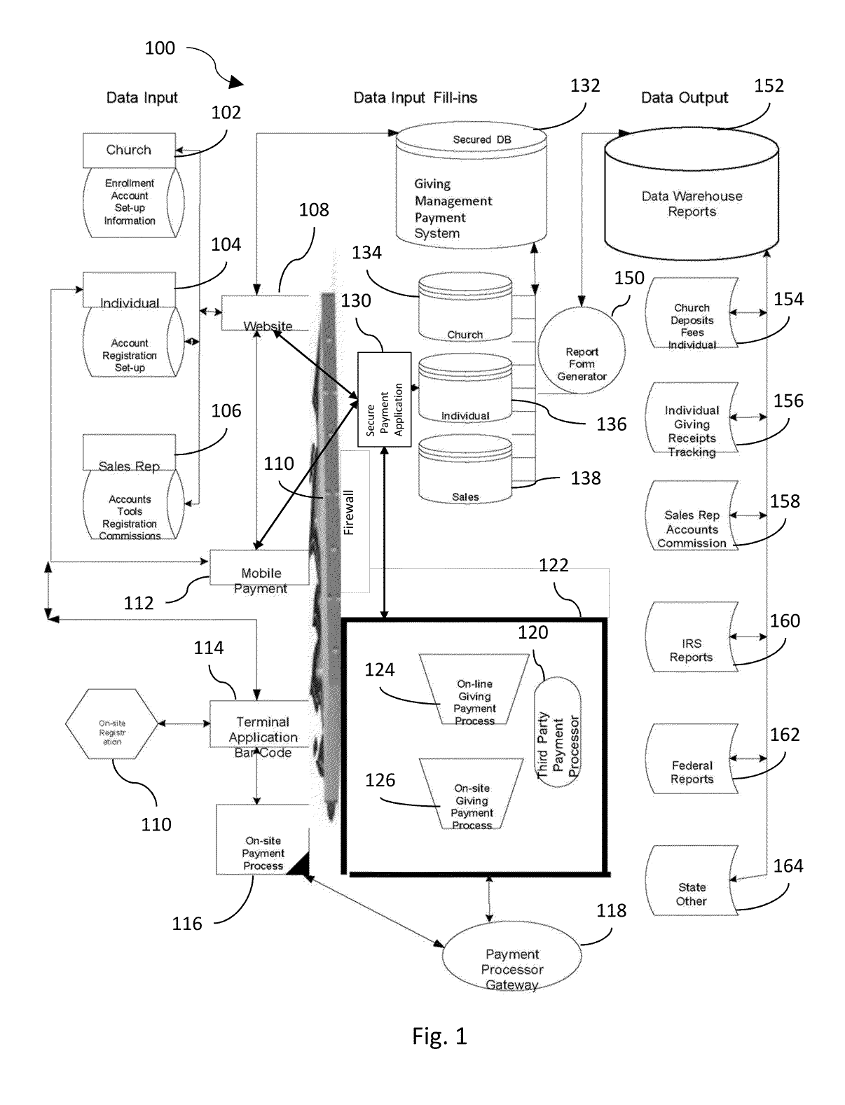

FIG. 1 is a diagram illustrating the secure payment and reporting system 100. As used herein, the secure payment and reporting system 100 can also be referred to as a reporting system 100. The reporting system 100 can be divided into three sections, a data input section, a data input fill-in section, and a data output section.

The data input section can include functionality providing general access, account setup, and other tools that can be used by the non-profit, an individual, or a sales representative. For the non-profit 102, there can be, e.g. enrollment, account, and account setup functions. For the individual 104, there can be, e.g. account, account setup information, etc. For the sale representative 106, there can be, e.g. account, sales/account management tools, registration tools to register new payers, tools for managing commissions, etc.

The payment data can be received by a client device, for example, a kiosk, a mobile device, a website or payment webpage, a client computer separate from the reporting system 100, etc.

The website 108 can be accessed either through on-site registration 110, e.g. a kiosk or computer terminal physically located at the non-profit, or through a mobile payment application 112. Both methods of accessing the reporting system 100 can generate a terminal application bar code 114 that provides an electronic receipt of the payment. For on-site payment, there can be an on-site payment process 116, e.g. scanning a credit card or check, which also generates the terminal application bar code 114, and transmits the payment data to a payment processor gateway 118. The payment processor gateway 118 can then transmit the payment data to third party payment processors 120 through a secured partition 122.

The data input fill-in section receives payment data by a secure payment application 130. The secure payment application 130 can receive tokenized user and payment data, from either the website 108 or the mobile payment application 112, which prevents the intermediary from having access to private financial information, but allows the confirmation of payment instructions and user identification. This is one part of the bifurcated processing system, where the payment data is compartmentalized into non-sensitive payment data, e.g. payer, amount, time, payee, etc. and sensitive payment data, e.g. credit card numbers, card verification values (CVVs), PINs, routing numbers, etc.

The sensitive payment data can optionally contain one or more elements of non-sensitive payment data e.g. including the name of the payer with the credit card number, but the non-sensitive payment data does not contain any elements of the sensitive payment data. The sensitive payment data can be passed through the secured partition 122, e.g. a firewall, password barrier, etc. to the third-party payment processor 120. The secured partition 122 handles the processing of the sensitive payment data by either an online giving payment process 124 or an onsite giving payment process 126. Once processed, the payment data is then transmitted to the third party payment processor 120.

The non-sensitive payment data can be saved by the reporting system 100 in a secured database 132. The secured database 132 can include any number of databases, including a non-profit database 134, an individual database 136, and a sales database 138 and can contain data taken from the non-profit 102, individual 104, and sales representative 106 data input, respectively.

The data output section can include the storage of reports and the distribution of reports to agencies, business entities, or individuals. The data output section can include a report generator 150 that generates reports stored in a data warehouse 152 for later distribution.

The report generator 150 can automatically take data from the secured database 132 to generate a report based on the non-sensitive payment data. As used herein, the reports are referred to as electronic reports, but can be electronic reports or non-electronic (physical) reports. Electronic reports can be data files, for example, text documents, portable document formats (PDF), ASCII, ZIP, or any other form of electronic file. Non-electronic reports can be, for example, paper reports, or computer media such as flash drives, CD-ROM, and so on, which can be physically produced and distributed to report recipients. A report recipient can require a report in a particular format that describes a payment. For example, reports used by the federal government can require different information than reports used by state governments. As shown in FIG. 1, for example, there can be non-profit reports 154, individual reports 156, sales reports 158, tax reports 160, federal reports 162, and state reports 164. The report can require some or all of the non-sensitive payment data that was part of the received payment. Optionally, the report recipient can include one or more users, including the payee. This can include sending a copy of the report that was sent to the third party, or sending the report to the user for later relaying, by the user, of the report to the third party report recipient.

The report can be generated by accessing the data warehouse 152 can store report templates required by the report recipient. The report can be created based on one or more of the report templates. Once created, the report can be populated with non-sensitive payment data and excluding sensitive payment data.

Non-profit reports 154 can include information on deposits made to the payee, fees charged by the intermediary or third-party payment processor, and information about the payers, e.g. names, demographics, etc. Individual reports 156 can include information on amounts paid, receipt information, tracking information, etc. Sales reports 158 can include information on payer and payee accounts, commissions, sales statistics, etc.

The reports can also be sent to outside agencies, for example, the tax reports 160 can be sent to the IRS, state tax boards, etc. to comply with reporting requirements dictated by the government or local municipalities. Federal reports 162 and state reports 164 can be sent to the respective federal and state offices to comply with required or requested reporting requirements, e.g. PATRIOT ACT or federal consumer financial protection laws.

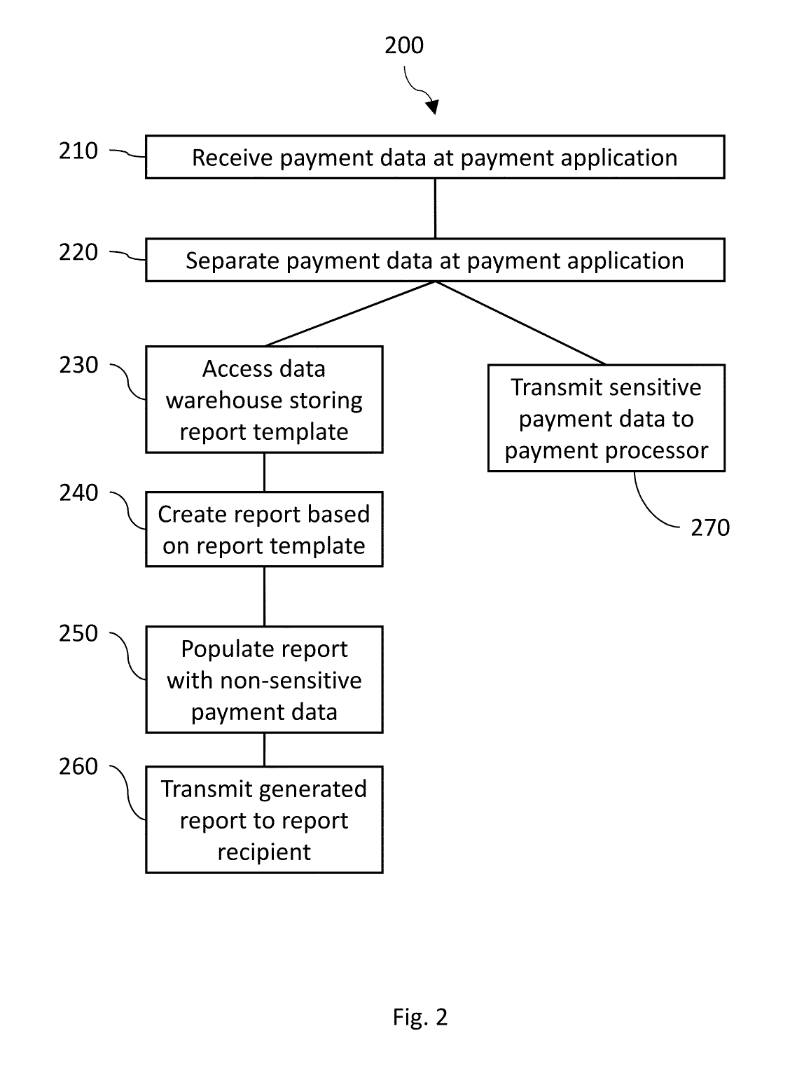

FIG. 2 is a process flow diagram 200 illustrating the bifurcation of payment data payment processing and report generation. As described in FIG. 1, the reporting system 100 utilizes a bifurcated payment and reporting process. The bifurcated process allows reports, needed for compliance with tax reporting or other legal requirements, to be generated separately from the processing of the payments by financial institutions.

At 210, payment data can be received at reporting system 100 over a communication network from a client device. The client device can include the website 108, a mobile device running a mobile payment application 112, a terminal application 114 that scans or generates a bar code as a receipt or payment method, an onsite payment process, 116, etc. The payment data can be received by the payment application 130 that processes the payment data as described below. The payment data can include at least two types of data. First, there can be the sensitive payment data required for processing a payment. The payment data can also include the non-sensitive payment data. The non-sensitive payment data, for example, can include some or all of the information required by a report recipient. The non-sensitive payment data can describe the processed payment, including for example, identifying information about the payee and/or the payment recipient, amounts, verification that the payment was completed, etc.

At 220, the payment data can be separated into the sensitive payment data and the non-sensitive payment data. The separation can be performed by the secure payment application 130, or other connected process in the reporting system 100. Again, the received payment data can be tokenized, or otherwise at least partially encrypted, to prevent the reporting system 100 from having access to the sensitive payment data in a form that can be readable by a person or otherwise improperly accessed.

Once the payment data has been separated, required reports can be generated and sent to report recipients. In one implementation, at 230, the data warehouse 152 can be accessed to retrieve stored report templates of the type required by the report recipients.

At 240, an electronic report can be created based the stored report templates. As discussed above, the creation of the electronic report can also encompass creation of physical reports. The stored report templates accessed in creating the electronic report can be specified by the user providing the payment data, or by the reporting system 100 in response to the payment data.

At 250, the electronic report can be populated with at least some of the non-sensitive payment data. In one implementation, the electronic report is not populated with any of the sensitive payment data. At 260, the payment application can transmit the electronic report to the report recipient.

Returning to the processing of the sensitive payment data, the sensitive payment data can be transmitted through the secured partition 122 from the payment application 130 to a payment processor 120. The payment processor 120 can then process the payment or transmit the sensitive payment data to any connected computing system. The generation of the electronic report can happen before, in parallel with, or after completion of the actual payment. In one implementation, the generation of the electronic report can be delayed until verification of the processing of the payment, and the receipt of payment verification. In another implementation, the electronic report can be generated automatically upon receiving the payment data. The automatically generated electronic report can be transmitted to the report recipient.

In one implementation, reports and records of payments made can be stored by the reporting system 100. At any time, the reporting system can receive a request for an electronic report corresponding to a previous payment. The report generator can generate the electronic report based on the report template that corresponds to the report recipient and the request. Again, the electronic report generated in this way includes non-sensitive payment data relating to the previous payment. Alternatively, the reporting system 100 can send an existing copy of a stored electronic report relating to a previous payment, without requiring the report generator to create a new electronic report from scratch.

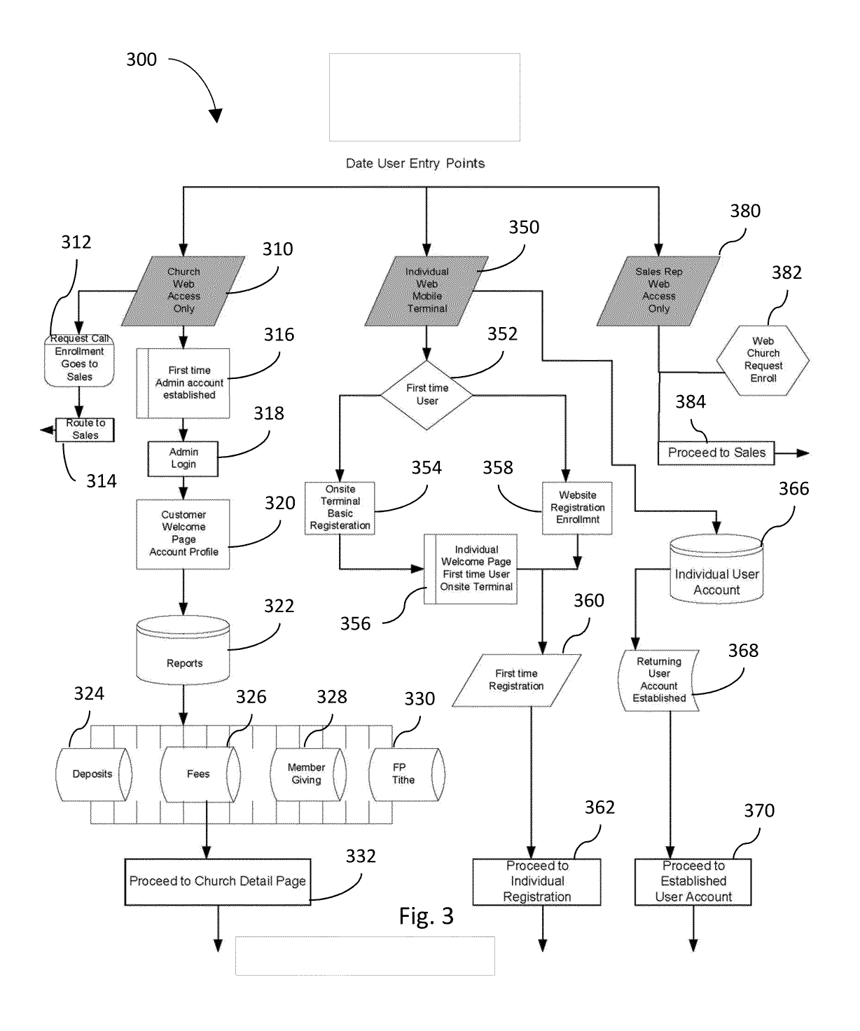

FIG. 3 is a process flow diagram 300 illustrating data user entry processes. As described in FIG. 1, in the data input section there can be non-profit input 102, individual input 104, and sales representative input 106. FIG. 3 describes those input processes in greater detail.

The non-profit access portal 310 can allow, at 312, a non-profit to request a call from a sales representative to assist them with establishing an account with the reporting system 100. At 314, the request can then be routed to sales for a follow-up call or other customer contact, e.g. email, text, etc. At 316, a first time administrative account can be established, signing up the non-profit for the reporting system 100. At 318, the non-profit can be given an administrative login and password to access and manage the account. At 320, a customer welcome page can be displayed that provides information to new customers about the reporting system 100. Also at 320, the non-profit can fill out or update their profile information for use by the reporting system 100. At 322, a reports database can be established that contains information of interest to the non-profit, e.g. deposits 324, fees 326, member giving 328, tithes 330, etc.

The deposits 324 information can contain data on what deposits were made to the non-profit accounts by the reporting system 100. The fees information 326 can contain information on fees charged by the reporting system 100 for processing donations or payments through the reporting system 100. The member giving information 328 can contain data and statistics on member giving, e.g. trends, tracking data, demographics, etc. The tithe information 330 can contain information on any tithes made to the non-profit by the reporting system 100 as a result of using the reporting system 100. After the reports database 322 has been set up, the non-profit is then directed to the non-profit detail page 332.

At 350, the individual can access the reporting system 100 through an individual terminal. At 352, if the individual is a first time user, then they can be enrolled by one of two methods. At 354, if they are enrolling onsite, then they can be enrolled by an onsite terminal basic registration process. At 356, after enrolling onsite, an individual welcome page for onsite users can be displayed. At 358, if they are using a website or a mobile device, they can be enrolled by a website registration enrollment process. At 360, it is determined that the individual is a first-time user, based on the above choices. Then at 362, the individual proceeds to the individual registration for first-time users.

At 366, if the individual is not a first-time user, they can access their individual user account. At 368, the returning user account has been established and associated with the individual requesting access. At 370, the individual then proceeds to their established user account.

At 380, if the user is a sales representative, they can access the system to manage sales accounts. At 382, if there is a new non-profit that wants to be enrolled in the reporting system 100, an enrollment request can be generated. At 384, the sales representative can then proceed to sales to handle the management of existing accounts or the creation of new accounts.

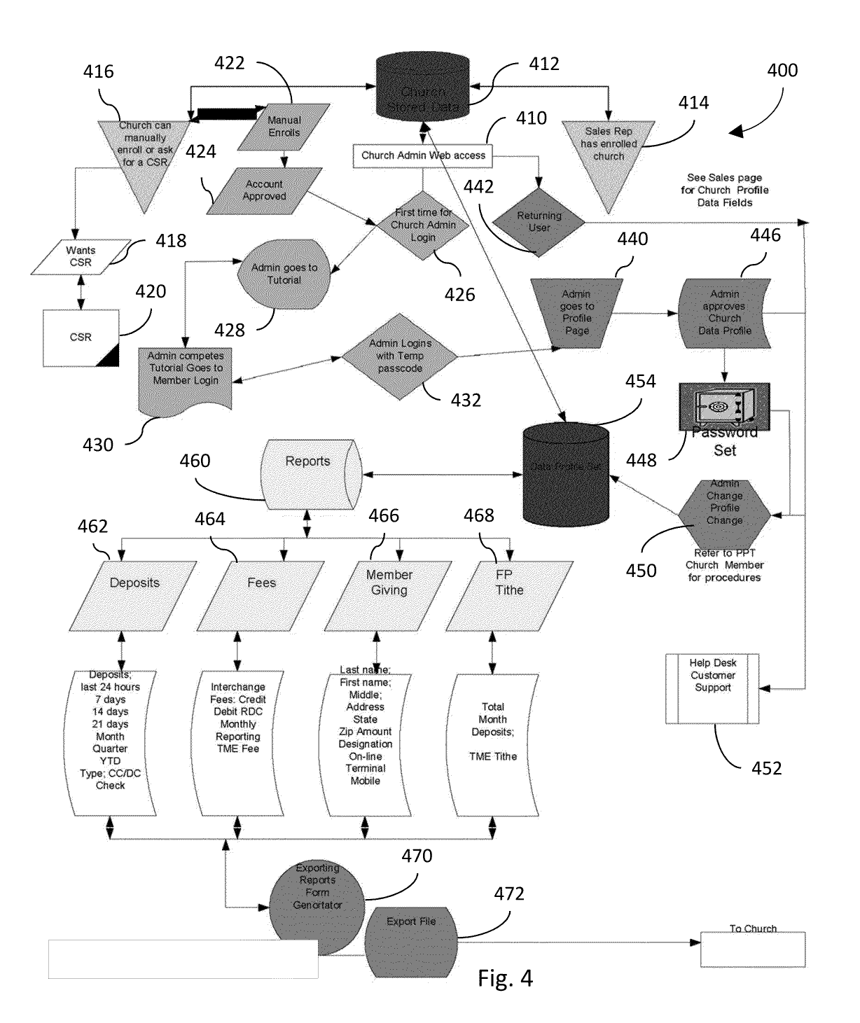

FIG. 4 is a process flow diagram 400 illustrating non-profit webpage functionality. The non-profit can use the reporting system 100 to manage all aspects of record-keeping and reporting to individuals and to government agencies. At 410, the non-profit accesses the reporting system 100 through a website, which can be displayed on, e.g. a terminal, mobile device, kiosk, etc. At 414, the non-profit can be enrolled by a sales representative. At 416, the non-profit can enroll manually, or request assistance from a customer service representative. At 418, it is determined that the non-profit wants the help of a customer service representative. At 420, the non-profit is connected with the customer service representative to assist with enrollment.

At 422, it is determined that the non-profit wishes to be enrolled manually. At 424, the new account for the non-profit is established. At 426, it is determined that this is a first-time login for the non-profit. At 428, the non-profit then performs a tutorial to educate the non-profit on how to use the reporting system 100. At 430, the tutorial is completed and a member login screen is displayed. At 432, the non-profit completes the login with a temporary passcode.

At 440, with a completed enrollment, the non-profit is directed to a profile page displaying information about the non-profits profile. At 442, it can be determined that the non-profit is a returning user. At 446, from either 440 or 442, the reporting system 100 can approve any changes to the non-profit's profile. At 448, if the profile change is a password change, the password can be securely reset by the reporting system administration. At 450, other changes to the non-profit's profile can be effected by the reporting system administration. At 452, help desk customer support can be contacted by either the non-profit or the reporting system administration to complete the profile changes. At 454, the data profile set can be updated and accessed by the non-profit stored data 412, as needed.

At 460, 462, 464, 466, and 468, reports can be generated as described in 322, 324, 326, 328, and 330, respectively. For example, at 462, deposits can be displayed daily, weekly, monthly, etc. At 464, fees can be displayed by type, e.g. interchange fees, credit fees, debit fees, etc. At 466, member giving can be displayed by personal information, amounts, point-of-giving, etc. At 468, tithes to the non-profit by the reporting system can be displayed by total amounts for a given time period, etc. At 470 the report generator generates the requested reports. At 470, the report is exported as a file to the non-profit.

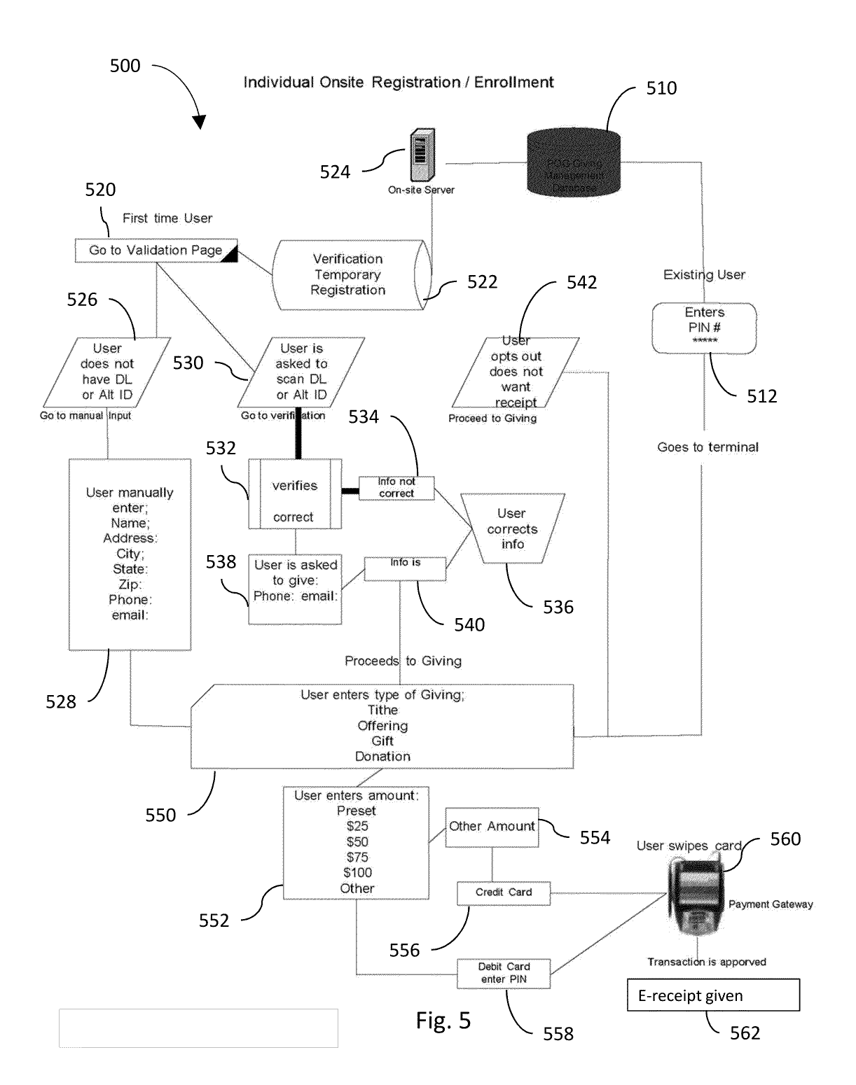

FIG. 5 is a process flow diagram 500 illustrating individual onsite enrollment. In one embodiment the process for executing onsite enrollment of individuals can be performed as described below. At 510, the reporting system 100 can include a management database that can contain information regarding user accounts. At 512, if the user is an existing user, a password or PIN can be entered to allow access. At 520, if the user is a first time user, it the identity of the user is determined. At 533, if the user has a temporary registration, the temporary registration is verified. At 524, an onsite server can be accessed when a user wishes to make a payment or donation, or to verify the identity of a user with a temporary registration. The onsite server can communicate with the management database to access the user account records. At 526, it is determined that the user does not have a driver's license or alternate ID. At 528, the user manually enters information such as their name, address, etc. At 530, if the user does have a driver's license or alternate ID, they are asked to scan the ID. At 532, after scanning the ID, verification is made to determine if the information culled from the scanned ID is correct. At 534, it is determined that the information is not correct. At 536, the user can manually correct the information. At 538, the user can be asked to provide other information, e.g. phone numbers, email addresses, etc. that are not typically found on ID cards. At 540, it is determined that the information, whether scanned or manually entered, is now correct.

At 550, the type of payment is determined. The type of payment can be a tithe, offering, gift, donation, etc. At 552, the user enters an amount that can be selected from a list, e.g. $25, $50, $100, etc. At 554, the user can enter an amount not found on the list of preset payment amounts. At 556, the other amount from 554 can be processed by a credit card. At 558, a debit card PIN is entered to process payment of the preset amounts. At 560, the card, e.g. credit, debit, etc. can be swiped at a payment gateway. At 562, once the transaction is approved, an electronic receipt can be sent to the email address provide by the user at 538.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving, over a communication network from a client device, payment data at a payment application in a reporting system, the payment data comprising:
sensitive payment data required for processing a payment; and
non-sensitive payment data required by a report recipient that describes the processed payment;
separating, by at least one data processor, the payment data into the sensitive payment data and the non-sensitive payment data;
generating, by the at least one data processor executing a report generator, an electronic report describing the payment, the generating comprising:
accessing a data warehouse storing at least one report template required by the report recipient;
creating the electronic report based on at least one of the stored report templates; and
populating the electronic report with at least a portion of the non-sensitive payment data and excluding any of the sensitive payment data;
transmitting, over the communication network by the at least one data processor executing the payment application, the electronic report to the report recipient; and
transmitting, over the communication network by the at least one data processor through a secured partition, the sensitive payment data from the payment application to a payment processor.

2. The computer-implemented method of claim 1, wherein the payment data is tokenized to prevent the reporting system from accessing private financial information contained in the sensitive payment data.

3. The computer-implemented method of claim 1, wherein the electronic report is generated automatically upon receiving the payment data.

4. The computer-implemented method of claim 3, further comprising transmitting the automatically generated electronic report to the report recipient.

5. The computer-implemented method of claim 1, further comprising:
receiving, from the client device, a selection of at least one of a collection of report recipients; and
generating, by the report generator, the electronic report based on the report template that corresponds to the selected at least one report recipients, the electronic report comprising non-sensitive payment data relating to at least one previous payment.

6. The computer-implemented method of claim 1, further comprising:
receiving, from the report recipient, a request for at least one electronic report corresponding to at least one previous payment; and
generating, by the report generator, the electronic report based on the report template that corresponds to the report recipient and the request, the electronic report comprising non-sensitive payment data relating to the at least one previous payment.

7. A computer program product comprising a non-transient machine-readable medium storing instructions which, when executed by at least one programmable processor, cause the at least one programmable processor to perform operations comprising:
receiving, over a communication network from a client device, payment data at a payment application in a reporting system, the payment data comprising:
sensitive payment data required for processing a payment; and
non-sensitive payment data required by a report recipient that describes the processed payment;
separating, by at least one data processor, the payment data into the sensitive payment data and the non-sensitive payment data;
generating, by the at least one data processor executing a report generator, an electronic report describing the payment, the generating comprising:
accessing a data warehouse storing at least one report template required by the report recipient;
creating the electronic report based on at least one of the stored report templates; and
populating the electronic report with at least a portion of the non-sensitive payment data and excluding any of the sensitive payment data;
transmitting, over the communication network by the at least one data processor executing the payment application, the electronic report to the report recipient; and
transmitting, over the communication network by the at least one data processor through a secured partition, the sensitive payment data from the payment application to a payment processor.

8. The computer program product of claim 7, wherein the payment data is tokenized to prevent the reporting system from accessing private financial information contained in the sensitive payment data.

9. The computer program product of claim 1, wherein the electronic report is generated automatically upon receiving the payment data.

10. The computer program product of claim 9, further comprising transmitting the automatically generated electronic report to the report recipient.

11. The computer program product of claim 7, further comprising:
receiving, from the client device, a selection of at least one of a collection of report recipients; and
generating, by the report generator, the electronic report based on the report template that corresponds to the selected at least one report recipients, the electronic report comprising non-sensitive payment data relating to at least one previous payment.

12. The computer program product of claim 7, further comprising:
receiving, from the report recipient, a request for at least one electronic report corresponding to at least one previous payment; and
generating, by the report generator, the electronic report based on the report template that corresponds to the report recipient and the request, the electronic report comprising non-sensitive payment data relating to the at least one previous payment.

13. A system comprising:
a client device; and
a reporting system configured to perform operations comprising:
receiving, over a communication network from the client device, payment data at a payment application in a reporting system, the payment data comprising:
sensitive payment data required for processing a payment; and
non-sensitive payment data required by a report recipient that describes the processed payment;
separating, by at least one data processor, the payment data into the sensitive payment data and the non-sensitive payment data;
generating, by the at least one data processor executing a report generator, an electronic report describing the payment, the generating comprising:
accessing a data warehouse storing at least one report template required by the report recipient;
creating the electronic report based on at least one of the stored report templates; and
populating the electronic report with at least a portion of the non-sensitive payment data and excluding any of the sensitive payment data;
transmitting, over the communication network by the at least one data processor executing the payment application, the electronic report to the report recipient; and
transmitting, over the communication network by the at least one data processor through a secured partition, the sensitive payment data from the payment application to a payment processor.

14. The system of claim 13, wherein the payment data is tokenized to prevent the reporting system from accessing private financial information contained in the sensitive payment data.

15. The system of claim 13, wherein the electronic report is generated automatically upon receiving the payment data.

16. The system of claim 15, further comprising transmitting the automatically generated electronic report to the report recipient.

17. The system of claim 13, further comprising:
receiving, from the client device, a selection of at least one of a collection of report recipients; and
generating, by the report generator, the electronic report based on the report template that corresponds to the selected at least one report recipients, the electronic report comprising non-sensitive payment data relating to at least one previous payment.

18. The system of claim 13, further comprising:
receiving, from the report recipient, a request for at least one electronic report corresponding to at least one previous payment; and
generating, by the report generator, the electronic report based on the report template that corresponds to the report recipient and the request, the electronic report comprising non-sensitive payment data relating to the at least one previous payment.
